(19) United States
(12) Patent Application Publication
(10) Pub. No.: US 2007/0009349 A1
(43) Pub. Date: Jan. 11, 2007

(54) IMPINGEMENT BOX FOR GAS TURBINE SHROUD

(75) Inventors: John D. Ward Jr., Woodruff, SC (US); Kevin L. Worley, Easley, SC (US); Daniel David Snook, Moore, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/160,809

(22) Filed: Jul. 11, 2005

(51) Int. Cl. F03B 11/00

(52) U.S. Cl. 415/115

(57) ABSTRACT

An impingement box for a turbine shroud. The impingement box may include a first side with an air access aperture positioned therein and a second side with a number of impingement holes positioned therein. The second side may be positioned a predetermined distance above a floor of the shroud such that the impingement holes provide a cooling flow to the floor of the shroud.

### TECHNICAL FIELD

The present invention relates generally to gas turbines and more particularly relates to an impingement box for a stage one shroud of a gas turbine.

### BACKGROUND OF THE INVENTION

A known approach to increasing the efficiency of gas turbine engines is to raise the turbine operating temperature. Several of the turbine engine components, however, must have advanced cooling given these elevated operating temperatures. One particular gas turbine component that is subject to extremely high temperatures is the turbine shroud. The turbine shroud defines in part the hot gas path therethrough.

Specifically, the inner shroud body defines in part the hot gas path that generally is cooled with cooling air from the compressor. This cooling air is required such that the structural integrity of the shroud and the hot gas path clearances may be maintained. For example, known stage one shroud designs direct airflow from the stage one nozzle to the stage two nozzle set with flow interaction along the interior floor of the shroud.

Other known shroud designs have used an impingement plate to direct the stage one shroud cooling flow onto the interior floor of the shroud for enhanced cooling. The cooling flow, however, is not channeled directly into the impingement box. The post-impingement flow is then purged to the hot gas path. Another of the drawbacks associated with this approach is that the post-impingement flow to the hot gas path may adversely impact the efficiency of the turbine as a whole and also may increase the associated operating costs.

There is a desire, therefore, for an impingement cooling system that substantially reduces these cooling inefficiencies and is able to accommodate the desired higher operating temperatures associated with a turbine shroud. The cooling system is directed primarily, but not exclusively, to a stage one turbine shroud.

### SUMMARY OF THE INVENTION

The present application thus describes an impingement box for a turbine shroud. The impingement box may include a first side with an air access aperture positioned therein and a second side with a number of impingement holes positioned therein. The second side may be positioned a predetermined distance above a floor of the shroud such that the impingement holes provide a cooling flow to the floor of the shroud.

The impingement box may be removable from the shroud. A hollow connector may extend from the impingement box through the shroud. A number of the impingement holes may be positioned on the first side. The impingement holes may include about a seventeen by eleven array. The impingement holes may include a diameter of about 0.03 inches (about 0.76 millimeters) and may be spaced at a distance of about 0.34 inches (about 8.6 millimeters) apart from each other. The cooling flow may be a cross flow. The average heat transfer coefficient may be about 250 BTU/h*ft2*F.

A method described herein provides for cooling a shroud for use in a turbine. The method may include the steps of placing an impingement box within the shroud, communication cooling air to the impingement box, flowing the cooling air through a number of impingement holes within the impingement box, and splitting the flow of the cooling air into two streams as it exits the impingement holes. The method may include an average heat transfer coefficient of about 250 BTU/h*ft2*F.

The present application further may describe a shroud for use with a turbine. The shroud may include a cooling flow entrance, a floor, an impingement box positioned above the floor, and a hollow connector in communication with the cooling flow entrance and the impingement box. The impingement box may include a number of impingement holes positioned so as to provide a cooling flow to the floor of the shroud.

The impingement box may be removable from the shroud. The impingement box may be made out of stainless plate steel. The impingement holes may include about a seventeen by eleven array. The impingement holes may include a diameter of about 0.03 inches (about 0.76 millimeters) and may be spaced a distance of about 0.34 inches (about 8.6 millimeters) apart from each other. The impingement holes may be spaced a predetermined distance from the floor. The cooling flow may be a cross flow.

These and other features of the present invention will become apparent to one of ordinary skill in the art upon review of the following detailed description when taken in conjunction with the drawings and the appended claims.

### BRIEF DESCRIPTION OF THE DRAWINGS

FIG. 1 is a schematic diagram of a turbine engine.

FIG. 2 is a side plan view of a known turbine shroud.

FIG. 3 is a perspective view of a turbine shroud with an impingement box as is described in detail herein.

FIG. 4 is an exploded view of the shroud and the impingement box of FIG. 3.

FIG. 5 is a perspective view of an impingement plate of the impingement box of FIG. 3.

FIG. 6 is a bottom plan view of the impingement plate of FIG. 5.

FIG. 7 is a side plan view of the shroud with the impingement box of FIG. 3.

### DETAILED DESCRIPTION

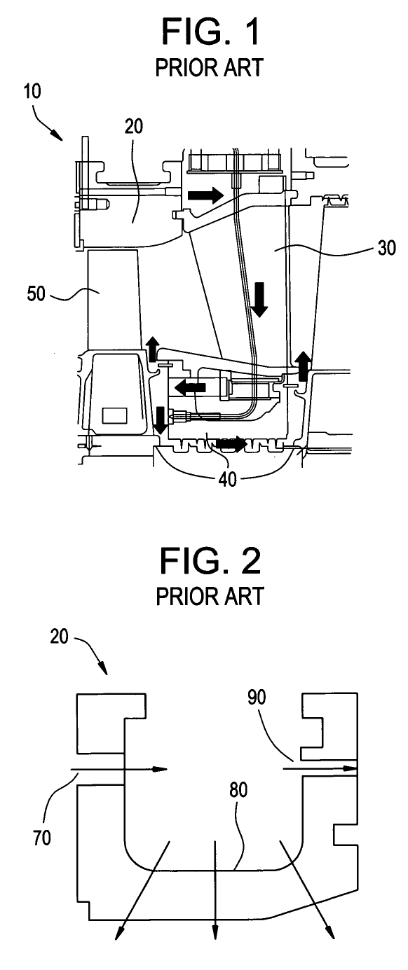

Referring now to the drawings, in which like numerals refer to like elements throughout the several views, FIG. 1 shows a gas turbine engine 10. The gas turbine engine 10 may be known in the art. The gas turbine engine 10 includes a stage one shroud 20. As described above, the stage one shroud 20 receives a flow of cooling air from the compressor (not shown). In turn, the stage one shroud 20 provides the cooling air to a stage two nozzle 30. Further cooling flows advance through a diaphragm 40 and a stage one bucket 50 also is shown. In this example, a fourteenth stage 60 extraction also is used. Many variations are possible in the design of the gas turbine engine 10 as a whole and the individual components thereof.

FIG. 2 shows a side cross-sectional view of the stage one shroud 20. As is shown, the stage one shroud 20 includes a cooling flow entrance 70 in communication with the compressor, cooling flow across an interior floor 80, and a cooling flow exit 90 in communication with the stage two nozzle 30. The interior floor 80 also is cooled via seal leakage as is known. The stage one shroud 20 may be made out of Haynes HR-120 material or similar types of high temperature tolerant materials.

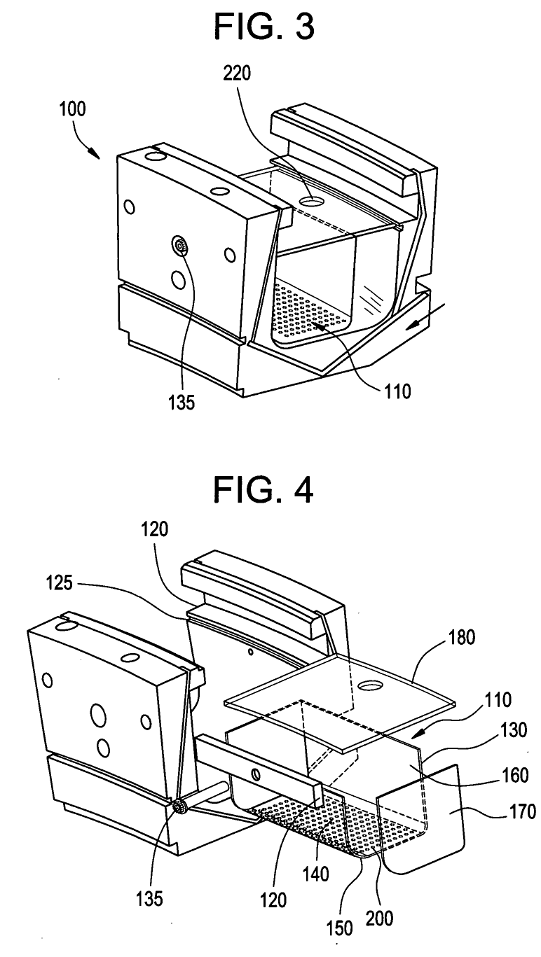

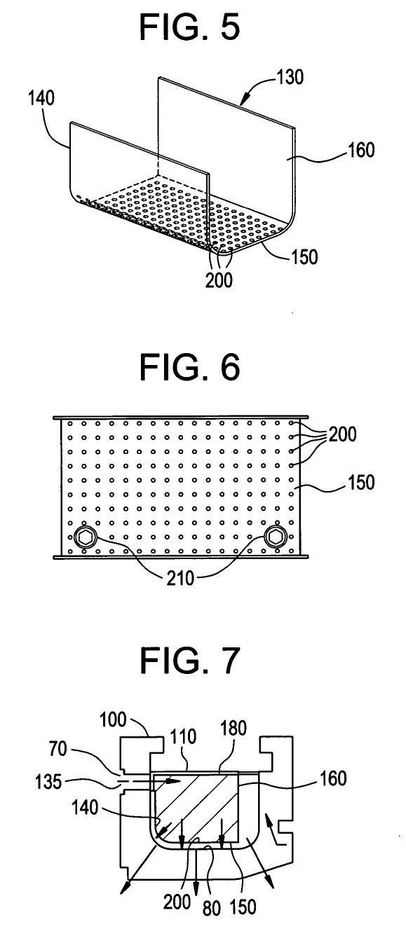

FIGS. 3 through 7 show a stage one shroud 100 as is described herein. The stage one shroud 100 may be similar to the stage one shroud 20 with removal of the cooling flow exit 90. The stage one shroud 100 also includes an impingement box 110 positioned therein. The impingement box 110 is positioned within the shroud 100 via pair of attachment plates 120. The attachment plates 120 may be welded or otherwise attached to the sides of the shroud 100. The attachment plates 120 each may have a rail 125 or a similar structure formed therein. The impingement box 110 slides into the shroud 100 along the rails 125. Other types of attachment means may be used herein. The attachment plates 120 also allow for independent expansion of the shroud 100 against the impingement box 110. The impingement box 110 may be removable.

The impingement box 110 may be secured to the stage one shroud 110 and in communication with the compressor via a hollow attachment bolt 135. The attachment bolt 135 may be positioned within the cooling flow entrance 70. Other types of attachment means and/or cooling air flow communication means also may be used. The attachment bolt 135 and the cooling flow entrance 70 are positioned so as to provide the cooling air flow within the impingement box 110.

The impingement box may include an impingement plate 130. The impingement plate 130 may be three (3) sided so as to include a front side 140, a bottom side 150, and a back side 160. The impingement plate 130 further may be enclosed by a pair of side plates 170 and a top plate 180. The impingement plate 130, the side plates 170, and the top plate 180 may be assembled and welded. Other attachment means may be used herein. The impingement box 110 may be made out of stainless steel plate with a thickness of about 0.05 inches (about 1.27 millimeters). The front side 140 of the plate 130 and the top plate 180 may have an increased thickness of about 0.15 inches (about 3.8 millimeters) to ensure structural integrity of the box 110 as a whole. The steel plate may be an AISI-3040SS material or similar types of materials. Other materials and thicknesses may be used herein.

The bottom side 150 of the plate 130 includes a number of impingement holes 200. The impingement holes 200 also may extend partially up the front side 140 of the plate 130. In this example, the impingement holes 200 may be positioned in a 17 by 11 array. Any desired number or positioning of the impingement holes 200, however, may be used. The diameter of the impingement holes 200 may be about 0.03 inches, (about 0.76 millimeters) and the holes 200 may be spaced about 0.34 inches (about 8.6 millimeters) apart from each other. Again, other sizes, shapes, and positionings may be used herein. The impingement holes 200 may be cut via a water jet, a laser jet, or similar methods.

The bottom side 150 of the plate 130 also may have a pair of dimples 210 positioned thereon. The dimples 210 maintain the proper distance between the bottom side 150 of the plate 130 and the floor 80 of the stage one shroud 100 so as to ensure the desired airflow therethrough.

The top plate 180 may extend beyond the back side 160 of the plate 130 and may include an aperture 220 positioned therein. The aperture 220 may provide clearance for a probe to pass through.

FIG. 7 shows operation of the stage one shroud 100 with the impingement box 110 positioned therein. As is shown, the cooling flow enters via the attachment bolt 135 and passes through the impingement holes 200 towards the floor 80 of the shroud 100. After the cooling air passes through the impingement holes 200, the flow splits at about the circumferential centerline of the shroud 100, and subsequently flows over the seals, and provides additional leakage flow to the stage two nozzle 30. This particular cross-flow behavior enables the impingement scheme to cool the shroud 100 more effectively through optimization of the array of impingement holes 200. This optimization reduces the degradation of cooling effectiveness due to cross-flow effects as compared to known schemes in which all of the flow travels in one direction. Such a flow degrades the cooling effectiveness at the far end of the array of the impingement holes 200.

This cooling scheme results in an average heat transfer coefficient (“HTC”) of about 250 BTU/h*ft2*F. The impingement box 110 thus results in a decrease of about 10 degrees Fahrenheit (about 12.2 degrees Celsius) in average temperature over the turbine bucket tip region as compared to known models. The impingement box 110 may use about 0.39% of the total flow of the engine for impingement cooling. The efficiency and output of the gas turbine engine 10 thus may be increased without compromising component stability. Although the shroud 100 and the impingement box 110 may be used in an E class machine sold by General Electric Company of Schenectady, N.Y., the impingement box 110 also may be used in other types of turbine engines.

It should be apparent to one of ordinary skill in the art that the foregoing relates only to the preferred embodiments of the present invention and that numerous changes and modifications may be made herein without departing from the general spirit and scope of the invention as defined by the following claims and the equivalents thereof.

What is claimed is:

1. An impingement box for a turbine shroud, comprising:
a first side with an air access aperture positioned therein;
a second side with a plurality of impingement holes positioned therein; and
the second side positioned a predetermined distance above a floor of the shroud such that the plurality of impingement holes provide a cooling flow to the floor of the shroud.

2. The impingement box of claim 1, wherein a portion of the plurality of impingement holes are positioned on the first side.

3. The impingement box of claim 1, wherein the impingement box is removable from the shroud.

4. The impingement box of claim 1, further comprising a hollow connector extending from the impingement box through the shroud.

5. The impingement box of claim 1, wherein the plurality of impingement holes comprise about a seventeen by eleven array.

6. The impingement box of claim 1, wherein the plurality of impingement holes comprise a diameter of about 0.03 inches (about 0.76 millimeters).

7. The impingement box of claim 1, wherein the plurality of impingement holes comprise a distance of about 0.34 inches (about 8.6 millimeters) apart from each other.

8. The impingement box of claim 1, wherein the average heat transfer coefficient comprises about 250 BTU/h*ft2*F.

9. The impingement box of claim 1, wherein the cooling flow comprises a cross flow.

10. A method of cooling a shroud for use in a turbine, comprising:
placing an impingement box within the shroud;
communication cooling air to the impingement box;
flowing the cooling air through a plurality of impingement holes within the impingement box; and
splitting the flow of the cooling air into two streams as it exits the plurality of impingement holes.

11. The method of claim 10, wherein the method comprises an average heat transfer coefficient of about 250 BTU/h*ft2*F.

12. A shroud for use with a turbine, comprising:
a cooling flow entrance;
a floor;
an impingement box positioned above the floor;
a hollow connector in communication with the cooling flow entrance and the impingement box; and
the impingement box comprising a plurality of impingement holes positioned so as to provide a cooling flow to the floor of the shroud.

13. The shroud of claim 12, wherein the impingement box is removable from the shroud.

14. The shroud of claim 12, wherein the impingement box comprises stainless plate steel.

15. The shroud of claim 12, wherein the plurality of impingement holes comprise about a seventeen by eleven array.

16. The shroud of claim 12, wherein the plurality of impingement holes comprise a diameter of about 0.03 inches (about 0.76 millimeters).

17. The shroud of claim 12, wherein the plurality of impingement holes comprise a distance of about 0.34 inches (about 8.6 millimeters) apart from each other.

18. The shroud of claim 12, wherein the plurality of impingement holes comprises a predetermined distance from the floor.

19. The shroud of claim 12, wherein the cooling flow comprises a cross flow.
